(19) United States
(12) Patent Application Publication
(10) Pub. No.: US 2004/0130234 A1
(43) Pub. Date: Jul. 8, 2004

(54) Manual power generating device for handheld electronic unit

(76) Inventor: Reza H. Shah, Acton (CA)

Correspondence Address: DAVID W. WONG, 46 WILLOWBROOK ROAD, THORNHILL, ON, L3T 4W9, CA

(21) Appl. No.: 10/335,428

(22) Filed: Jan. 3, 2003

(51) Int. Cl. H02K 13/00; H01R 39/40

(52) U.S. Cl. 310/245

(57) ABSTRACT

A manually operative power supply device for an electronic unit is shown. The device has a crystal block having a high piezoelectric characteristic having a broad top surface. A hammer weight is spring mounted and is operative to strike the top surface of the crystal block so as to produce a generated voltage between the top surface and bottom surface of the crystal block. A capacitor is charged by the generated voltage until it is fully charged. The voltage of the fully charged capacitor provides the required electrical power to operate the electronic unit.

### FIELD OF INVENTION

This invention relates to a device for generating an electrical power, and more particularly relates to a device manually operative for providing an electrical supply to a handheld electronic unit such as a remote control unit which only requires to operate intermittently.

### BACKGROUND OF THE INVENTION

Handheld battery operated electronic units such as remote control units are widely used in electrical appliances such as television, audio and video equipment, and other remote-controlled electronic and electrical devices. Some handheld electronic units consume a large amount of power due to their continuous operation during use while others such as a remote control unit for a television, consume less power since they are operated occasionally and only for a short instance. Nonetheless, all batteries of handheld electronic units must be replaced from time to time when their power has been depleted. As electronic units use a variety of different sizes of batteries, it has been very frustrating for the users to obtain the correct sizes of batteries for replacement. Furthermore, most batteries contain materials that are harmful to the natural environment or would cause an explosion if negligently disposed of in a hot atmosphere. Thus, batteries must be disposed of with special care rather than just with common garbage in order not to cause pollution of the environment or an accidental explosion. For the above reasons, it is highly desirable to eliminate the use of batteries in electrical and electronic units.

### SUMMARY OF THE INVENTION

It is a principal object of the present invention to provide a device which may be incorporated to a handheld electronic unit and is operative to generate the electrical supply required for the operation of such unit.

It is another object of the present invention to provide a device which can be easily attached to or integrally incorporated in an electronic unit which only requires electrical power to operate intermittently.

It is yet another object of the present invention to provide a device which is simple in construction and is easy to operate.

### BRIEF DESCRIPTION OF THE DRAWINGS

This invention may take physical form in certain parts and arrangements of parts, preferred embodiments of which will be described in detail in this specification and illustrated in the accompanying drawings which form a part hereof and wherein:

FIG. 1 is a perspective top elevation view of the basic components of the device of the present invention operative for generating the electrical supply for an electronic unit.

FIG. 2 is an isolated side elevation view and schematic electrical circuit showing the general construction of a preferred embodiment of the device of the present invention.

### DETAILED DESCRIPTION OF THE PREFERRED EMBODIMENTS

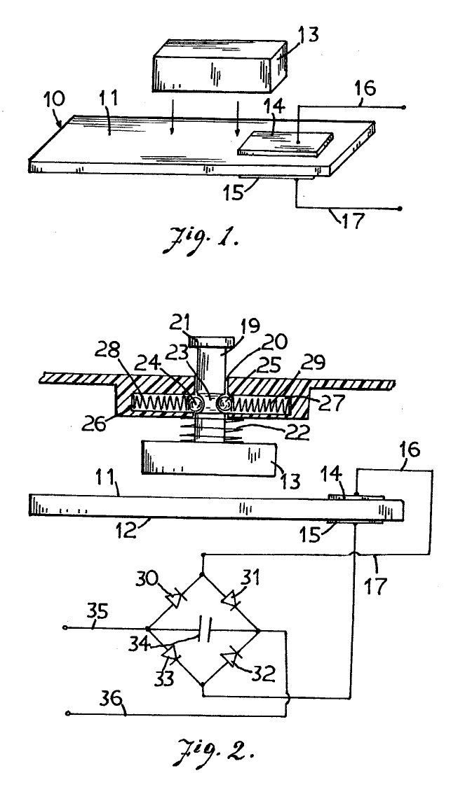

When a crystal of high piezoelectricity such as barium titanate is subjected to a force applied on its appropriate axis a voltage is generated across the crystal. This may be achieved as shown in FIG. 1, in which a high piezoelectric crystal 10 having a top surface 11 and a bottom surface 12. A force or impact may be exerted on the top surface 11 by a weight 13 so that a voltage is generated between the top surface 11 and the bottom surface 12. Two metal conductor plates 14 and 15 are provided on the top surface 11 and the bottom surface 12 respectively to collect the generated voltage which may then be outputted through conductor wires 16 and 17 connected to the conductor plates 14 and 15 respectively.

The device of the present invention utilizes such phenomenon to generate the electrical power for operating an electronic unit. The device may be integrally incorporated in the electronic unit or alternatively it may be constructed in a separate enclosure to which the electronic unit is mounted. For simplicity of illustration, the following embodiment shows the device constructed in a separate enclosure to which the electronic unit may then be mounted.

The high piezoelectric crystal block 10 is mounted within an enclosure having a top panel 18. A hammer weight 13 is mounted on a vertical shaft 19 which is slidably mounted in an opening 20 formed in the top panel 18 of the enclosure. A press button 21 is provided at the top end of the shaft 19. A tension coil spring 22 surrounding the shaft 19 is connected between the hammer weight 13 and the panel 18. The coil spring 22 maintains the hammer weight 13 normally spaced from the crystal block 10. The hammer weight 13 may be operated to strike the top surface 11 of the crystal block 10 by depressing the press button 21. In order to ensure that a consistent force is exerted on the top surface 11 by the hammer weight 13 a latching mechanism is provided. The latching mechanism includes a circumscribing circular groove 23 formed on the shaft 19. The groove 23 normally engages with two round pressure balls 24 and 25 mounted in two elongated closed end openings 26 and 27 respectively formed in two opposite sides of the side wall of the opening 20 of the top panel 17. The pressure balls 24 and 25 are pressed transversely against the groove 23 by compression springs 28 and 29 located respectively in the elongated openings 26 and 27. The compression springs 28 and 29 have a high spring force such that the pressure balls 24 and 25 are pressed tightly against the groove 23 of the shaft 19. Due to the high pressure exerted on the groove 23 by the pressure balls 24 and 25 to latch the shaft 19 in the normal position, a relatively high force must be exerted on the press button 21 in order to unlatch the shaft 19 for moving the hammer weight 13 to contact the top surface 11 of the crystal block 10. This operation causes the shaft 19 to unlatch and move the hammer weight 13 to strike the top surface 11 of the crystal block 10 with an impact force such that a voltage is produced between the top surface 11 and its bottom surface 12. When the pressure is released from the button 21, the tension spring force of the tension coil spring 22 will pull the hammer weight 13 back to its original upper position with the groove 23 again engaging with the pressure balls 24 and 25 to latch the shaft 19 in its normal upper position.

The voltage produced between the top surface 11 and the bottom surface 12 of the crystal block 10 is collected by the metal plates 14 and 15 and is conducted by wires 16 and 17 to pass through a rectifier bridge circuit consisting of diodes 30, 31, 32, and 33 to charge a capacitor 34. The voltage across the terminals 35 and 36 of the fully charged capacitor 34 provides the required power to operate the electronic unit.

It should be understood, of course, that the foregoing disclosure relates to only a preferred embodiment of the invention and that numerous modifications or alterations may be made therein without departing from the spirit and the scope of the invention set forth in the appended claims.

What I claim is:

1. A power generation device for an electronic apparatus, comprising
a crystal block having a high piezoelectric characteristic, said crystal block having a top surface and a bottom surface,
a hammer weight member mounted in a spaced manner from said top surface of said crystal block, said hammer weight member being operative to strike said top surface of said crystal block with an impact to produce a generated voltage between said top surface and said bottom surface,
a capacitor operative to be charged by said generated voltage to provide the power for said electronic apparatus.

2. A power generation device according to claim 1 including a first metal plate disposed on said top surface and a second metal plate disposed on said bottom surface, said first metal plate and second metal plate adapted to collect said generated voltage from said crystal block.

3. A power generation device according to claim 2 wherein said hammer weight member is mounted on a shaft slidably mounted in a mounting opening of a top panel of an enclosure, a tension coil spring surrounding said shaft and having one end connected to said hammer weight member and a second end connected to said top panel, said coil spring providing a biassing force for maintaining said hammer weight normally in said spaced manner from said top surface of said crystal block.

4. A power generation device according to claim 3 including a press button mounted at a top end of said shaft and being operative with a downward pressure against said biassing force to move said hammer weight against said top surface of said crystal block.

5. A power generation device according to claim 4 including a circumscribing groove formed on said shaft, two circular balls pressure mounted in two elongated openings formed in opposite side wall locations of said mounting opening, said circular balls engage under pressure with said groove for latching said shaft at normal upper position.

6. A power generation device according to claim 5 including a full wave bridge rectifier electrically connected between said capacitor and said first metal plate and said second metal plate.
